(19) United States
(12) Patent Application Publication
(10) Pub. No.: US 2010/0196613 A1
(43) Pub. Date: Aug. 5, 2010

(54) METHOD AND APPARATUS FOR COATING A FIBER BUNDLE

(75) Inventor: Harri TURUNEN, Dacula, GA (US)

Correspondence Address: OLIFF & BERRIDGE, PLC, P.O. BOX 320850, ALEXANDRIA, VA, 22320-4850, US

(73) Assignee: NEXTROM OY, Vantaa (FI)

(21) Appl. No.: 12/620,406

(22) Filed: Nov. 17, 2009

(30) Foreign Application Priority Data
Feb. 3, 2009 (FI) 20095097

(51) Int. Cl. B05D 1/02; B05B 13/02

(52) U.S. Cl. 427/424; 118/307

(57) ABSTRACT

A method and an apparatus for coating a fiber bundle, the fiber bundle comprising at least three fibers and the method comprising guiding the fiber bundle to travel through a first and a second chamber formed by means of a first, a second and a third nozzle part of a nozzle means, whereby coating material is fed to the fiber bundle through the chambers. The fibers of the fiber bundle are kept separate from each other in the first nozzle part, so that the coating material gets to penetrate between the fibers in the first chamber; the fibers are guided into a position against each other in the second nozzle part, so that the coating material surrounds the uniform fiber bundle in the second chamber; and the fiber bundle is guided onwards through the third nozzle part to provide the final fiber bundle diameter.

The invention relates to a method of coating a fiber bundle, the fiber bundle comprising at least three fibers and the method comprising guiding the fiber bundle to travel through a first and a second chamber formed by means of a first, a second and a third nozzle part of a nozzle means, whereby coating material is fed to the fiber bundle through the chambers. The invention further relates to an apparatus for coating a fiber bundle, the fiber bundle comprising at least three fibers and the apparatus comprising a nozzle means which comprises a first, a second and a third nozzle part arranged to form a first and a second chamber which are arranged to be connected to means for feeding coating material into the chambers, whereby the fiber bundle is arranged to be guided to travel through the nozzle parts and the chambers, the coating material being arranged to come into contact with the fiber bundle travelling through the chambers and thus to form a coating for the fiber bundle.

In connection with optical fibers, one essential work stage is forming a coating for fibers and fiber bundles. One basic arrangement in coating fibers and fiber bundles has been the use of various open crucibles in which the fiber or fiber bundle is drawn through a crucible filled with coating material, whereby the coating material adheres to the surface of the fibers. One restriction of such a solution has been that the draw rate cannot be raised sufficiently high in relation to the present production rates.

Later, in aiming at higher draw rates, pressurized crucibles have been introduced which have allowed the draw rate to be raised to significantly higher values as compared with previous open systems. Pressurized crucibles and high draw rates enabled by them have involved drawbacks of eccentric coating but, owing to continuous development work, it has been possible to alleviate them rather efficiently.

One example of a coating system according to the prior art is the solution known from Fl patent publication 74269 or US patent publication 4 713 103 corresponding to this Fl publication.

A problem of the prior art, particularly in connection with fiber bundles, has been the penetration of water inside a fiber bundle coated in the longitudinal direction of the fibers. This problem arises because the inside of the fiber bundle is not filled with coating material when the coating takes place with conventional tool structures. Cavities easily remain between fibers, and water or moisture gets to proceed along these cavities in the longitudinal direction of the fibers.

Within cabling industry, there have been attempts to solve the above problem by adding to the coating line a grease fill in which grease is extruded to the inside of a fiber bundle by means of pressure. However, implementing a grease feed on a coating line is difficult and, in other respects, often unnecessary what it comes to the manufacturing process. Using a grease feed also contributes to increasing the coating costs.

An object of the invention is to provide a method and an apparatus by means of which drawbacks of the prior art can be eliminated. This is achieved with the method and the apparatus according to the invention. The method according to the invention is characterized by keeping the fibers of the fiber bundle separate from each other in the first nozzle part, so that the coating material gets to penetrate between the fibers in the first chamber; guiding the fibers into a position against each other in the second nozzle part, so that the coating material surrounds the uniform fiber bundle in the second chamber; and guiding the fiber bundle onwards through the third nozzle part to provide the final fiber bundle diameter. The apparatus according to the invention, in turn, is characterized in that the first nozzle part comprises a separate passage opening for each fiber in such a way that the fibers of the fiber bundle are separate from each other when travelling through the first nozzle part, so that the coating material in the first chamber gets to penetrate between the fibers; that the second nozzle part comprises one opening common to the fiber bundles and having a diameter arranged such that it guides the fibers of the fiber bundle against each other, whereby the coating material in the second chamber comes into contact with the uniform fiber bundle; and that the third nozzle part comprises one common opening having a diameter arranged to form the final diameter for the fiber bundle.

An advantage of the invention is, above all, that a grease feed can be omitted and drawbacks caused by the penetration of water can be eliminated. Thus, clear material savings are achieved by means of the invention. A further advantage of the invention is its simplicity, owing to which the invention may be applied in a preferable manner in connection with various production lines.

In the following, the invention will be explained in greater detail with reference to an embodiment shown in the attached drawing, whereby

FIG. 1 shows a principled cross-sectional view of a cable;

FIG. 2 shows a principled view of a coating line of a cable at the point to be coated;

FIGS. 3 to 6 show principled section views of different parts of an embodiment of a nozzle part of an apparatus according to the invention, seen from one side;

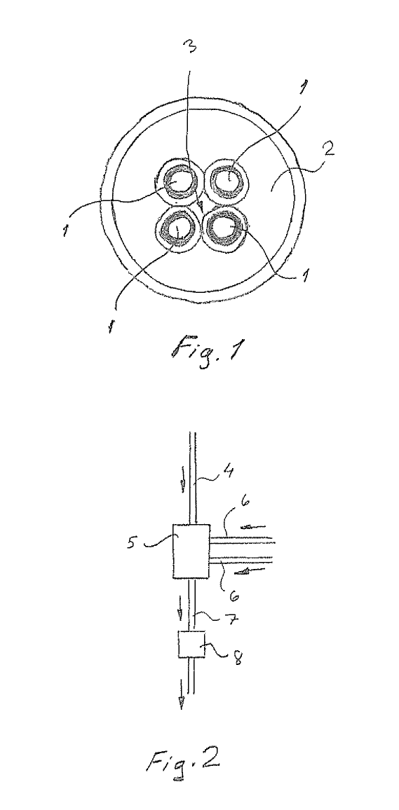

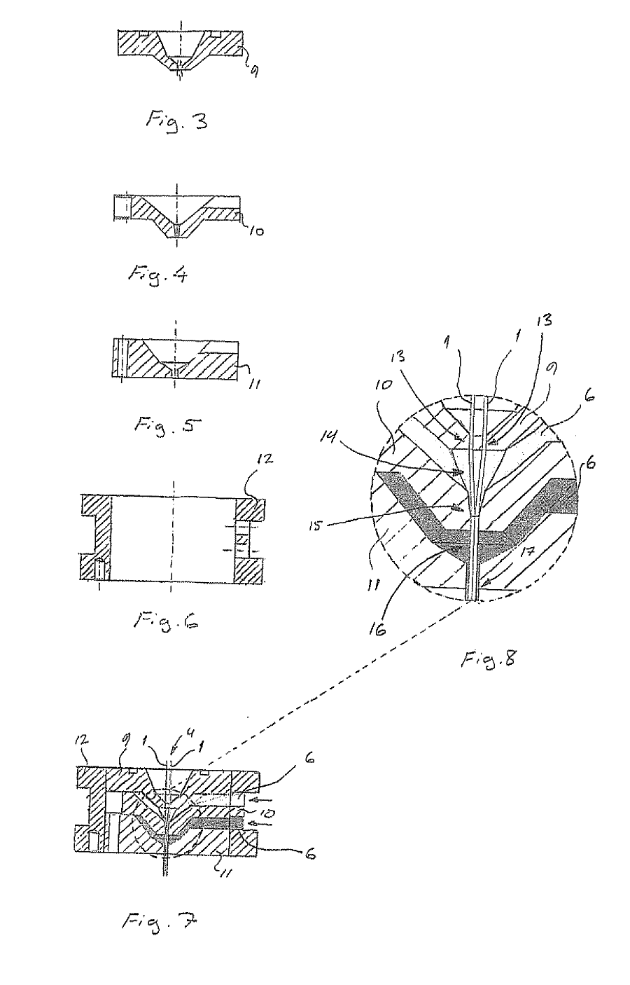

FIG. 7 shows an assembled form of the nozzle part of FIGS. 3 to 6; and

FIG. 8 shows a detail of FIG. 7 in a larger scale.

FIG. 1 shows a principled cross-sectional view of a cable. Optical fibers are denoted with reference numeral 1. There are four optical fibers 1 in the example of FIG. 1. A fiber bundle formed of the fibers 1 is coated with coating material 2. The coating material 2 may be, for example, acrylate material or other suitable material, for instance material curable with UV radiation.

As noted above, the prior art involves the drawback that the inside of a fiber bundle is not filled with coating material, whereby cavities easily remain there and water may get to proceed along these cavities in the longitudinal direction of the fibers. Reference numeral 3 in FIG. 1 denotes, by way of example, a point where it is difficult for the coating material 2 to get to when prior art is used.

FIG. 2 shows, by way of principle, a part of a cable coating line. Reference numeral 4 in FIG. 2 indicates a fiber bundle. Reference numeral 5 indicates a coating head. A feed of the coating material to the coating head is indicated, by way of principle, with reference numeral 6. Reference numeral 7 shows a fiber bundle coated with the coating material. Reference numeral 8 shows, by way of principle, an apparatus in which the coating material is cured. As noted above, the apparatus 8 may comprise ultraviolet lamps, for example.

The coating head 5 comprises a nozzle means by means of which the coating material 2 is arranged on the surface of the fiber bundle 4. The invention relates to this nozzle means. The nozzle means is illustrated in FIG. 7 and it comprises nozzle parts 9, 10 and 11 that are shown individually in FIGS. 3, 4 and 5. The nozzle means is assembled to form one entity by arranging the nozzle parts inside a substantially cylindrical frame part 12. The frame part 12 is shown as a separate part in FIG. 6.

FIG. 7 also shows the fiber bundle 4 and the fibers 1 of the fiber bundle. Only two fibers 1 are visible in the figure. The other two fibers 1 are behind the fibers visible in FIG. 1, so there are four fibers in the embodiment of FIG. 7 as well.

In principle, the nozzle means works in such a way that the fiber bundle is drawn through the nozzle parts 9, 10, 11 arranged on top of each other, and coating material 2 is fed into the chambers formed between the nozzle parts, whereby the coating material adheres to the fiber bundle. In FIG. 7, the feed of the coating material 2 is indicated, by way of principle, with reference numeral 6 in the same way as in FIG. 2.

An essential aspect of the invention is that the fibers 1 of the fiber bundle 4 are kept separate from each other in the first nozzle part 9, so that the coating material gets to penetrate between the fibers in the first chamber. In this way, formation of harmful cavities inside the fiber bundle is eliminated. In the second nozzle part 10, the fibers 1 are guided into a position against each other, so that the coating material surrounds the uniform fiber bundle in the second chamber. The fiber bundle is guided onwards through the third nozzle part 11 to provide the final diameter for the coated fiber bundle.

The above aspects are clearly illustrated in FIG. 8, which shows a detail of FIG. 7 in a larger scale.

As presented above, what is essential in the invention is that the first nozzle part 9 comprises a separate passage opening 13 for each fiber 1, so that the fibers 1 of the fiber bundle 4 are separate from each other when travelling through the first nozzle part 9. Thus, the coating material in the first chamber 14 gets to penetrate between the fibers, as shown in FIG. 8. The second nozzle part 10 comprises one opening 15 common to the fiber bundles and having a diameter arranged such that it guides the fibers 1 of the fiber bundle against each other, whereby the coating material in the second chamber 16 comes into contact with the uniform fiber bundle. This detail is also clearly shown in FIG. 8. The third nozzle part 11 comprises one common opening 17 having a diameter which is arranged to form the final diameter for the coated fiber bundle.

The nozzle parts 9, 10 and 11 may naturally be formed in a way required in each particular case. A particularly preferable structure has turned out to be one where the first nozzle part 9 and the second nozzle part 10 are formed in such a way that the distance between these nozzle parts is greater than the distance between the second nozzle part 10 and the third nozzle part 11. In this way, the transition angle of the distances between the fibers 1 of the fiber bundle can be made sufficiently gentle when the fibers are guided into a position against each other. Thus, it is ensured that the fibers can travel as smoothly and with as low friction as possible. The arrangement also eliminates formation of too sharp angles on the line of travel of the fibers.

The above embodiment of the invention is by no means intended to restrict the invention but the invention may be varied completely freely within the claims. As presented above, for example the nozzle parts may naturally be formed completely freely as required in each particular case. The first nozzle part, for instance, is naturally provided with as many passage openings as there are fibers in the fiber bundle, for instance three, four, five etc.

1. A method of coating a fiber bundle, the fiber bundle comprising at least three fibers, the method comprising the following:
guiding the fiber bundle to travel through a first chamber and a second chamber formed by a first nozzle part, a second nozzle part and a third nozzle part of a nozzle,
feeding coating material to the fiber bundle through the first chamber and the second chamber,
keeping the at least three fibers of the fiber bundle separate from each other in the first nozzle part, so that the coating material penetrates between the at least three fibers in the first chamber;
guiding the at least three fibers into a position against each other to form a uniform fiber bundle in the second nozzle part, so that the coating material surrounds the uniform fiber bundle in the second chamber, and
guiding the uniform fiber bundle onwards through the third nozzle part to provide a final fiber bundle diameter.

2. An apparatus for coating a fiber bundle, the fiber bundle comprising at least three fibers and the apparatus comprising a nozzle that comprises a first nozzle part, a second nozzle part and a third nozzle part arranged to form a first chamber and a second chamber that are arranged to be connected to means for feeding a coating material into the first chamber and the second chamber, wherein the fiber bundle is arranged to be guided to travel through the nozzle parts and the chambers, the coating material being arranged to come into contact with the fiber bundle travelling through the chambers and thus to form a coating for the fiber bundle, the first nozzle part comprising a separate passage opening for each fiber in such a way that the at least three fibers of the fiber bundle are separate from each other when travelling through the first nozzle part, so that the coating material in the first chamber penetrates between the at least three fibers, the second nozzle part comprising one opening common to the fiber bundle and having a diameter arranged such that it guides the at least three fibers of the fiber bundle against each other to form a uniform fiber bundle, wherein the coating material in the second chamber comes into contact with the uniform fiber bundle, and the third nozzle part comprising one common opening having a diameter arranged to form the final diameter for the fiber bundle.

3. An apparatus according to claim 2, wherein a distance between the first nozzle part and the second nozzle part is greater than a distance between the second nozzle part and the third nozzle part to reduce distances between the fibers of the fiber bundle in order to obtain a gentle transition angle before the second nozzle part.

4. The method according to claim 1, wherein a distance between the first nozzle part and the second nozzle part is greater than a distance between the second nozzle part and the third nozzle part to reduce distances between the fibers of the fiber bundle in order to obtain a gentle transition angle before the second nozzle part.
